(19) United States
(12) Patent Application Publication
(10) Pub. No.: US 2022/0245490 A1
(43) Pub. Date: Aug. 4, 2022

(54) SYSTEM AND METHOD FOR HETEROGENEOUS MULTI-TASK LEARNING WITH EXPERT DIVERSITY

(71) Applicant: ROYAL BANK OF CANADA, Toronto (CA)

(72) Inventors: Raquel AOKI, Burnaby (CA); Frederick TUNG, North Vancouver (CA); Gabriel L. OLIVEIRA, Vancouver (CA)

(21) Appl. No.: 17/592,196

(22) Filed: Feb. 3, 2022

Related U.S. Application Data
(60) Provisional application No. 63/145,260, filed on Feb. 3, 2021.

(51) Int. Cl. G06N 5/04; G06N 3/04

(52) U.S. Cl. CPC G06N 5/043; G06N 3/0454

(57) ABSTRACT

A computer system and method for training a heterogeneous multi-task learning network is provided. The system comprises at least one processor and a memory storing instructions which when executed by the processor configure the processor to perform the method. The method comprises assigning expert models to each task, processing training input for each task, and storing a final set of weights. For each task, weights in the expert models and in gate parameters are initialized, training inputs are provided to the network, a loss is determined following a forward pass over the network, and losses are back propagated and weights are updated for the experts and the gates. At least one task is assigned one exclusive expert model and at least one shared expert model accessible by the plurality of tasks.

### CROSS REFERENCE TO RELATED APPLICATIONS

This application is a non-provisional of, and claims all benefit, including priority to U.S. Application No. 63/145,260, dated Feb. 3, 2021, entitled SYSTEM AND METHOD FOR HETEROGENEOUS MULTI-TASK LEARNING WITH EXPERT DIVERSITY, incorporated herein in its entirety by reference.

### FIELD

The present disclosure relates generally to machine learning, and in particular to a system and method for heterogeneous multi-task learning with expert diversity.

### INTRODUCTION

In single-task learning (STL), a separate model is trained for each target. Multi-task learning (MTL) optimizes a single model to predict multiple related tasks/targets simultaneously, and has been applied in many areas such as computer vision, robotics, and natural language processing to improve generalization and reduce computational and memory requirements. Standard MTL settings usually assume a homogeneous set of tasks, for example all tasks are classification or regression tasks, and usually they are non-sequential data. There is a need for better MTL for a heterogeneous set of tasks.

### SUMMARY

In some embodiments, there is provided a system and method for multi-task learning of heterogeneous tasks. Heterogeneous MTL is defined by multiple classes of tasks, such as classification, regression with single or multi-label characteristics and temporal data, being optimized simultaneously.

In some embodiments, diversity of expert models in multi-gate mixture-of-experts (MMoE) is introduced, together with novel exclusion and exclusivity conditions, where some expert models only contribute to some tasks, while other expert models are shared amongst all tasks.

In some embodiments, a two-step task balancing optimization at the gradient level is introduced that enables the learning of unbalanced heterogeneous tasks, in which some tasks may be more susceptible to overfitting, more challenging to learn, or operate at different loss scales. Task balancing allows for the prevention of one or more tasks from dominating the optimization, to decrease negative transfer, and to avoid overfitting.

In one embodiment, there is provided a system for training a heterogeneous multi-task learning network. The system comprises at least one processor and a memory storing instructions which when executed by the processor configure the processor to assign expert models to each task, process training input for each task, and store a final set of weights. For each task, weights in the expert models and in gate parameters are initialized, training inputs are provided to the network, a loss is determined following a forward pass over the network, and losses are back propagated and weights are updated for the expert models and the gate parameters. At least one task is assigned one exclusive expert model and at least one shared expert model accessible by the plurality of tasks.

In another embodiment, there is provided a method of training a heterogeneous multi-task learning network. The method comprises assigning expert models to each task, processing training input for each task, and storing a final set of weights. For each task, weights in the expert models and in gate parameters are initialized, training inputs are provided to the network, a loss is determined following a forward pass over the network, and losses are back propagated and weights are updated for the experts and the gates. At least one task is assigned one exclusive expert model and at least one shared expert model accessible by the plurality of tasks.

In various further aspects, the disclosure provides corresponding systems and devices, and logic structures such as machine-executable coded instruction sets for implementing such systems, devices, and methods.

In this respect, before explaining at least one embodiment in detail, it is to be understood that the embodiments are not limited in application to the details of construction and to the arrangements of the components set forth in the following description or illustrated in the drawings. Also, it is to be understood that the phraseology and terminology employed herein are for the purpose of description and should not be regarded as limiting.

Many further features and combinations thereof concerning embodiments described herein will appear to those skilled in the art following a reading of the instant disclosure.

### DESCRIPTION OF THE FIGURES

Embodiments will be described, by way of example only, with reference to the attached figures, wherein in the figures:

FIGS. 1A to 1D illustrate examples of neural network architectures, where FIG. 1A illustrates single-task learning, FIG. 1B illustrates multi-task learning hard-parameter sharing, FIG. 1C illustrates multi-gate mixture-of-experts, and FIG. 1D illustrates multi-gate mixture-of-experts with exclusivity, in accordance with some embodiments;

FIG. 2 illustrates, in a schematic diagram, an example of a MMoExx learning platform, in accordance with some embodiments

FIG. 3 illustrates, in a flowchart, an example of a method of heterogeneous multi-task learning, in accordance with some embodiments

FIG. 4 illustrates an example of the input setting for MMoEEx, in accordance with some embodiments;

FIG. 5 illustrates, in a graph, the impacts of cardinality of experts for the MMoEEx model on MIMIC-III, in accordance with some embodiments;

FIG. 6 illustrates, in a plot diagram, with a comparison between the AUC for each task using MMoEEx and the baseline methods, in accordance with some embodiments;

FIG. 7 illustrates a comparison of the ROC AUC versus number expert in the MMoE and MMoEEx, in accordance with some embodiments;

FIGS. 8A and 8B illustrate, in plot diagrams, an example of MMoE and MMoEEx heatmaps in the MIMIC-III dataset, in accordance with some embodiments;

FIG. 9 illustrates, in a plot diagram, an example of MMoE and MMoEEx heatmaps for the PCBA dataset, in accordance with some embodiments; and

FIG. 10 is a schematic diagram of a computing device such as a server.

It is understood that throughout the description and figures, like features are identified by like reference numerals.

### DETAILED DESCRIPTION

Embodiments of methods, systems, and apparatus are described through reference to the drawings.

In the heterogeneous multi-task learning (MTL) setting, multiple tasks with different characteristics are optimized by the same model. Such a scenario can overwhelm current MTL approaches due to the challenges in balancing shared and task-specific representations, and the need to optimize tasks with competing optimization paths.

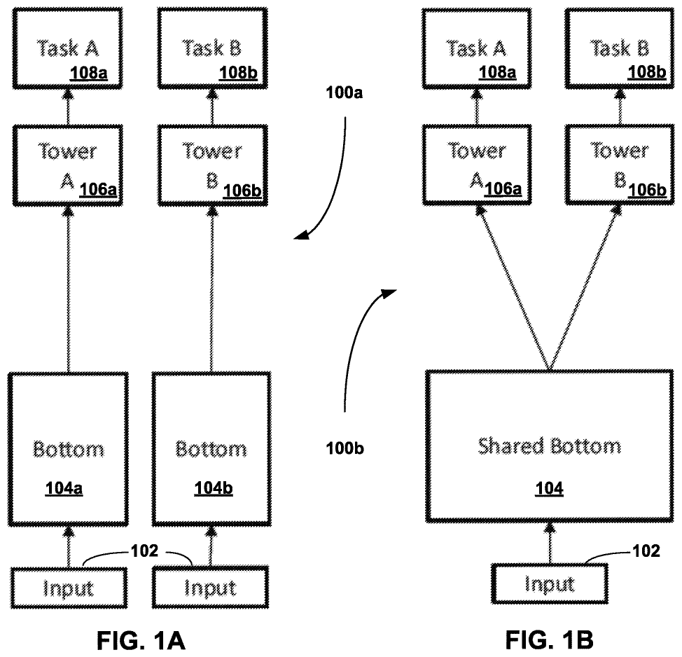

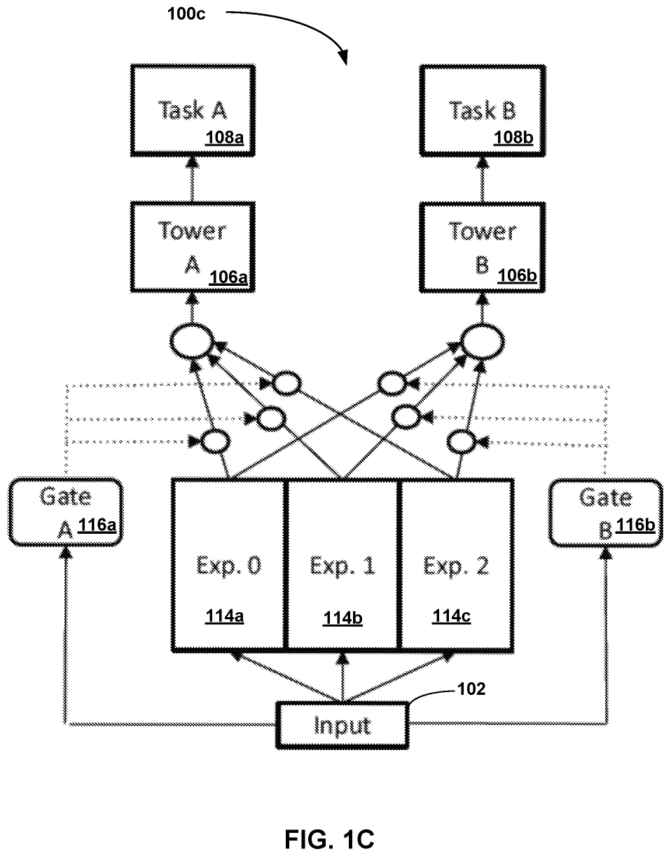

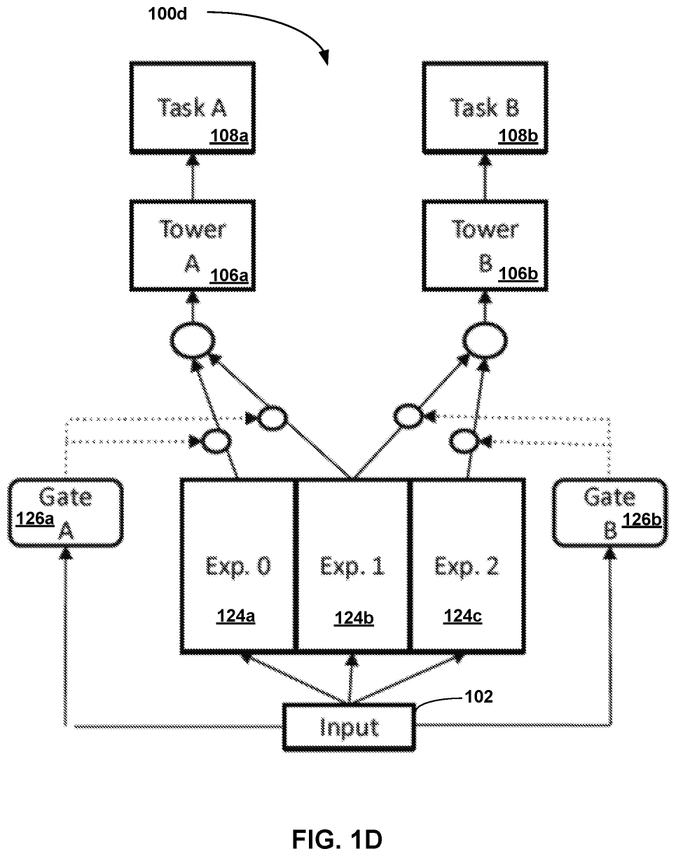

Single-task learning (STL) models are the most traditional approach in machine learning, and have been extremely successful in many applications. This approach assumes that for a given input sample, the model is required to output a single prediction target, such as a class label or a regression value. If two output targets are associated with the same input data 102, then two independent models 104a, 104b are trained: one for each target, or task 108a, 108b (see FIG. 1A). STL may be suitable for situations in which the tasks are very different from each other, and in which computational efficiency may be ignored. However, when the tasks are related, STL models are parameter inefficient. In addition, in some applications, the synergy among tasks can help a jointly trained model better capture shared patterns that would otherwise be missed by independent training. For example, in computer vision, the synergy between the dense prediction tasks of semantic segmentation (the assignment of a semantic class label to each pixel in an image) and depth estimation (the prediction of real-world depth at each pixel in an image) can be leveraged to train a single neural network that achieves higher accuracy on both tasks than independently trained networks.

In some embodiments, multi-gate mixture-of-experts with exclusivity (MMoEEx) is provided. In some embodiments, a MMoEEx approach induces more diversity among experts, thus creating representations more suitable for highly imbalanced and heterogenous MTL learning. In some embodiments, a two-step optimization approach is provided to balance the tasks at the gradient level. MTL benchmark datasets, including Medical Information Mart for Intensive Care (MIMIC-III) and PubChem BioAssay (PCBA) are provided below to validate and show that MMoEEx achieves better or competitive results with respect to these baselines, especially on heterogeneous time-series tasks.

FIGS. 1A to 1D illustrate examples of neural network architectures. FIG. 1A illustrates single-task learning (STL) 100a. FIG. 1B illustrates multi-task learning hard-parameter sharing 100b. FIG. 1C illustrates multi-gate mixture-of-experts (MMoE) 100c. FIG. 1D illustrates multi-gate mixture-of-experts with exclusivity (MMoEEx) 100d, in accordance with some embodiments.

In contrast to STL, multi-task learning (MTL) optimizes a single model to perform multiple related tasks simultaneously, aiming to improve generalization and parameter efficiency across tasks. In this case, two or more output targets are associated with the same input data (See FIGS. 1B, 1C and 1D). Effective MTL typically requires task balancing to prevent one or more tasks from dominating the optimization, to decrease negative transfer, and to avoid overfitting. Standard MTL settings usually assume a homogeneous set of tasks, for example all tasks are classification or regression tasks, and usually they are non-sequential data. This scenario can greatly benefit MTL approaches with strong shared representations. In contrast, heterogeneous MTL is defined by multiple classes of tasks, such as classification, regression with single or multi-label characteristics and temporal data, being optimized simultaneously. The latter setting is more realistic but lacks further exploration. As shown below, the MMoEEx approach described herein can better handle heterogeneous MTL.

A multi-gate mixture-of-experts (MMoE) model 100c is a model that combines experts (i.e., expert models 114a, 114b, 114c) using gate functions 116a, 116b. In this case, each expert 114a, 114b, 114c is one or more neural network layers shared among the tasks 108a, 108b. MMoE tends to generalize better than other models because it leverages several shared bottoms (experts) instead of using a single architecture. It allows dynamic parameter allocation to shared and task-specific parts of the network, thus improving further the representation power. MMoEEx takes advantage of these characteristics and extends them to heterogenous MTL problems.

The multi-gate mixture-of-experts with exclusivity (MMoEEx) model 100d is a new mixture-of-experts (MMoE) approach to MTL that boosts the generalization performance of traditional MMoE via contributions:

The experts in traditional MMoE are homogeneous, which limits the diversity of the learned representations. Inspired by ensemble learning, the generalization of traditional MMoE is improved by inducing diversity among experts. Novel exclusion and exclusivity conditions are introduced, under which some experts (e.g., 124a, 124c) only contribute to some tasks, while other experts (e.g., 124b) are shared among all tasks.

A two-step task balancing optimization at the gradient level is introduced. This enables MMoEEx to support the learning of unbalanced heterogeneous tasks, in which some tasks may be more susceptible to overfitting, more challenging to learn, or operate at different loss scales.

To understand how the MMoEEx approach behaves under a non-time series multi-task setting, MMoEEx was evaluated on the UCI Census-income dataset. The UCI Census-income dataset is a standard benchmark to MTL methods for low cardinality tasks. The benchmark was compared with several state-of-the-art multi-task models and show that MMoEEx outperforms the compared approaches for the hardest setting of the dataset.

The performance of MMoEEx was further evaluated on the heterogeneous time series multi-task learning dataset Medical Information Mart for Intensive Care (MIMIC-III). The mixture of multi-label and single-label temporal tasks with non-temporal binary classification makes this dataset ideal to benchmark MMoEEx. The large scale and high task imbalance characteristics of the dataset also provide a scenario to exploit the robustness of the MMoEEx approach to competing tasks. Improvements in the AUC metrics were observed against all compared approaches, especially the MMoE technique.

MMoEEx was also tested on the PubChem BioAssay (PCBA) dataset, which is a non-temporal homogeneous (only binary classification) high task cardinality dataset. PCBA is less challenging than the MIMIC-III but is the only available dataset with more than a hundred tasks, thus able to better benchmark scalability and negative transfer aspects of MTL approaches. The results (shown below) confirm the effectiveness of MMoEEx on large task cardinality datasets and show that the MMoEEx approach has performance on par with, or better than, the current state-of-the-art.

The recent works in deep learning for multi-task learning (MTL) can be divided into two groups: the ones focused on the neural network architecture, which study what, when and how to share information among the tasks; and the works focused on the optimization, which usually concentrate on how to balance competing tasks, which are jointly learned. The MMoEEx approach makes contributions to both technical fields.

MTL architectures can be divided into two main groups, hard parameter sharing and soft parameter sharing. One of the first works in MTL uses hard-parameter sharing. In this type of architecture, the bottom layers of the neural network (e.g., 104) are shared among all the tasks, and the top layers are task-specific. Another example of a shared bottom approach is UberNet. UberNet consists of a shared encoder that is followed by a series of task-specific decoding heads that merge encoder data from different layers and scales. On one hand, the main advantage of this class of methods is its scale invariance to a large number of tasks. On the other hand, with a shared representation the resulting features can become biased towards the tasks with strong signals.

The second group of MTL topologies have a dedicated set of parameters to each task. Such methods are called soft parameter sharing. They can be interpreted as single networks (e.g., 114a, 114b, 114c) that have a feature sharing mechanism between encoders to induce inter branch information crossing. Methods like cross-stitch network, multi-gate mixture of experts (MMoE) and multi-task attention network, are examples of soft parameter sharing based on an explicit feature sharing mechanism, mixture of experts feature fusion and attention based approaches to cross-task among branches. Soft-parameter sharing in deep multi-task approaches may be provided by learning a linear combination of the input activation maps. The linear combination (soft feature fusion) is learned at each layer from both tasks. The MMoE method is an attempt to provide a soft parameter sharing mechanic through a gating mechanism. The gate function 116a, 116b selects a set of experts for each task while re-using it for multiple tasks, consequently providing feature sharing. A new technique for soft parameter MTL is using attention mechanisms. The work called multi-task attention network (MTAN) used an attention mechanism to share the features for each task specific network. The main advantage of soft parameter sharing approaches is the capability of learning task specific and shared representations explicitly. Nevertheless, these models suffer from scalability problems, as the size of the MTL network tends to grow proportionally with the number of tasks.

The previously mentioned works focused on better network structures for MTL. Another problem of learning multiple tasks is related to the optimization procedure. MTL methods need to balance gradients of multiple tasks to prevent one or more tasks from dominating the network and producing task biased predictions. The optimization methods can be divided into loss balancing techniques, gradient normalization and model-agnostic meta-learning. A loss balance approach, based on loss ratios between the first batch and all subsequent ones in each epoch (loss-balanced task weighting (LBTW)) showed promising results reducing the negative transfer on a 128 task scenario. Another balancing approach operating in the loss level is the dynamic weight average (DWA). The main difference between them is that DWA will need to compute the average loss per epoch for each task before start the balancing procedure, thus operating in the epoch level and not on the batch level like LBTW. Loss balancing approaches have as their main drawbacks its sub-optimality when task gradients are conflicting or when a set of tasks have gradient magnitudes higher than others. In order to mitigate these limitations of loss based approaches, GradNorm and model-agnostic meta-learning (MAML) for MTL were proposed.

Gradient normalization aims to control the training through a mechanism that encourages all tasks to have similar magnitude. Additionally to it, the model also balances the pace tasks are learned. More recently methods based on meta-learning emerged and outperformed previous loss based approaches and gradient normalization techniques. A multi-step approach updates each task in an exclusive fashion. The method is capable of not only providing a balanced task optimization but also boosts current MTL architectures. MTL meta-learning methods, while being the current state-of-the-art class of approaches, can become impractical for settings with large cardinality based on the intermediate steps which are needed to task state computation.

The proposed multi-gate mixture-of-experts with exclusivity (MMoEEx) approach improved the MMoE approach and MAML. The MMoEEx modifies the MMoE approach with an exclusivity mechanism that provides an explicit sparse activation of the network, enabling the method to learn task specific features and a shared representation simultaneously. The scalability limitation of MMoE techniques are also tacked with exclusion gates. The MMoEEx approach also uses a two step approach to balance tasks at the gradient level for mixture of experts.

In some embodiments, experts selected will depend upon the tasks. If temporal data is used, then the experts may be considered as recurrent layers. If non-temporal data is used, then the experts may be considered as dense layers. Experts will learn differently since different tasks (or combination of tasks) are assigned to each expert during the learning phase.

### Methodology

Hard-parameter sharing networks shown in FIG. 1B are one of the pillars of multi-task learning. These networks are composed of a shared bottom 104 and task-specific branches. A unique shared bottom 104 might not be enough to generalize for all tasks in an application. Several shared bottom (or experts) 114a, 114b, 114c may be used. The experts are combined using gate functions 116a, 116b, and their combination is forwarded to the towers 106a, 106b. FIG. 1C shows another architecture: multi-gate mixture-of-Experts (MMoE) 100c. MMoE generalizes better than its traditional hard-parameter sharing counterpart, but there are some weaknesses. MMoE lacks a task-balancing mechanism. The only source of diversity among the experts is due to the random initialization. Although experts may be diverse enough if they specialize in different tasks, there are no guarantees that this will happen in practice. The MMoEEx is a model 110d that induces more diversity among the experts and has a task-balancing component.

### Structure

The neural network architecture 100d can be divided into three parts: gates 116a, 116b, experts 124a, 124b, 124c, and towers 106a, 106b. Considering an application with K tasks 108a, 108b, input data x∈ [symbol] d, the gate function g^{k}( ) is defined as:

g^{k}(x)=softmax(W^{k}x), ∀k∈{0, . . . , K} (1)

where W^{k}∈ [symbol] E×d are learnable weights and E is the number of experts, defined by the user. The gates 116a, 116b control the contribution of each expert to each task.

The experts fₑ( ),550 e∈{0, . . . , E}, and the MMoEEx implementation is flexible to accept several experts architectures, which is ideal to work with applications with different data types. For example, if working with temporal data, the experts can be LSTMs, GRUs, RNNs; for non-temporal data, the experts can be dense layers. In some embodiments, the number of experts E may be defined by the user. The experts 124a, 124b, 124c and gates' 116a, 116b outputs are combined as follows:

f^{k}(x)=Σₑ₌₀^{E}g^{k}(x)fₑ(x),∀k∈{0, . . . , L} (2)

The f^{k}( ) are input to the towers 106a, 106b, the task-specific part of the architecture 100d. Their design depends on the data type and tasks. The towers h^{k} l output the task predictions as follows:

y^{k}=h^{k}(f^{k}(x)),∀k∈{0, . . . , K} (3)

### Diversity

In ensemble learning, models with a significant diversity among their learners tend to generalize better. MMoE leverages several experts to make its final predictions; however, it relies only on random initialization to create diversity among the experts, and on the expectation that the gate function will learn how to combine these experts. In some embodiments, two mechanisms may induce diversity among the experts, defined as exclusion and exclusivity:

Exclusivity: αE experts are set to be exclusively connected to one task. The value α∈E [0, 1] controls the proportion of experts that will be exclusive. If α=1, all experts are exclusive, and if α=0, all experts are shared (same as MMoE). An exclusive expert is randomly assigned to one of the tasks Tₖ, but the task Tₖ can still be associated with other exclusive experts and shared experts.

Exclusion: Edges/connections between αE experts and tasks may be randomly excluded. If α=1, all experts will have one connection randomly removed, and if α=0, there is no edge deletion (same as MMoE).

For applications with only two tasks (K=2), exclusion and exclusivity mechanisms are identical. The exclusion mechanism is more scalable than the exclusivity mechanism because it does not require one expert per task, and therefore, works well in applications with a large number of tasks. For a small set of tasks, both approaches have similar results. MMoEEx, similarly to MMoE, relies on the expectation that gate functions will learn how to combine the experts. The MMoEEx approach induces more diversity by forcing some of these gates to be ‘closed’ to some experts, and the exclusivity and exclusion mechanisms are used to close part of the gates.

The remaining non-closed gates learn to combine the output of each expert based on the input data, according to Equation (1). In some embodiments, the diversity among the experts can be measured through the distance between the experts' outputs fₑ∀e∈{0, . . . , E}. Considering a pair of experts i and j, the distance between them is defined as:

$${d}_{i , j} \sqrt{{\sum }_{n = 0}^{N} {( {f}_{i} ( {x}_{n} ) - {f}_{j} ( {x}_{n} ) )}^{2} )}$$

where N is the number of samples in the dataset, d_{i,j}=d_{j,i}, and a matrix D∈ [symbol] E×E is used to keep all the distances. To scale the distances into d_{i,j}∈[0,1], we divide the raw entries in the distance matrix D by the maximum distance observed, max (D). A pair of experts i,j with d_{i,j}=0 are considered identical, and experts distances d_{i,j} close to 0 are considered very similar; analogously, experts with d_{i,j} close to 1 are considered very dissimilar. To compare the overall distance between the experts of a model, we define the diversity score d̅ as the mean entry in D.

As shown in Equation (2), the gates may be used as experts weights. Therefore, if an expert e∈{0, . . . , E} is exclusive to a task k∈{0, . . . , K}, then only the value g^{k}[e]≠0, and all other gates for that expert are ‘closed’: g^{m}[e]=0, m∈{0, . . . , K}, m≠k.

### MAML-MTL Optimization

The goal of the two-step optimization is to balance the tasks on the gradient level. In model-agnostic meta-learning (MAML), a two-step optimization approach originally intend to be used with transfer-learning and few-shot learning due to its fast convergence. MAML also has a promising future in MTL. MAML may be adopted for multi-task learning applications, showing that MAML can balance the tasks on the gradient level and yield better results than some existing task balancing approaches. The core idea is that MAML's temporary update yields smoothed losses, which also smooth the gradients on direction and magnitude.

MMoEEx adopts MAML. However, task specific layers are not frozen during the intermediate/inner updated. The pseudocode of our MAML-MTL approach is shown in Algorithm 1.

Algorithm 1: MAML-MTL

```
Sample batch X;
loss = 0;
for T in TASKS do
  Evaluate Δ_{θ} [symbol]   _{T} (f_{θ}(X));
  Temporary Update θ′_{T} ← θ − Δ_{θ} [symbol]   _{T} (f_{θ}(X));
  Re-evaluate and save loss = loss +Δ_{θ}_{_{T}}_{′} [symbol]  _{_{T}} (f_{θ}_{_{T}}_{′} (X));
Update θ ← θ − loss
```

Results of experiments using the two-step optimization strategy are provided below. One weakness of this approach is the running time. Temporary updates are expensive, making infeasible the use of MAML in applications with many tasks.

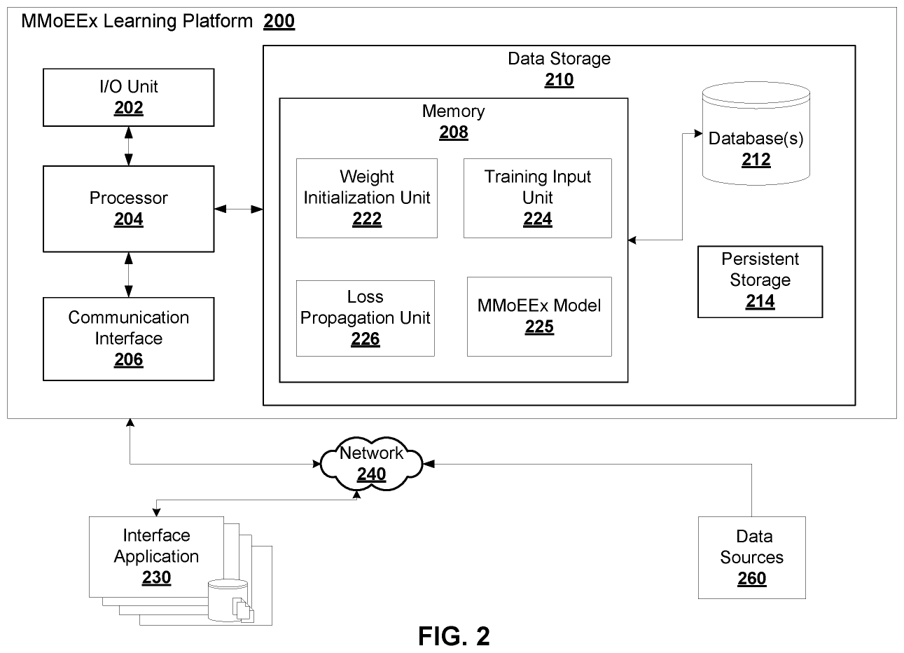

FIG. 2 illustrates, in a schematic diagram, an example of a MMoExx learning platform 200, in accordance with some embodiments. The platform 200 may be an electronic device connected to interface application 230 and data sources 260 via network 240. The platform 200 can implement aspects of the processes described herein.

The platform 200 may include a processor 204 and a memory 208 storing machine executable instructions to configure the processor 204 to receive a voice and/or text files (e.g., from I/O unit 202 or from data sources 260). The platform 200 can include an I/O Unit 202, communication interface 206, and data storage 210. The processor 204 can execute instructions in memory 208 to implement aspects of processes described herein.

The platform 200 may be implemented on an electronic device and can include an I/O unit 202, a processor 204, a communication interface 206, and a data storage 210. The platform 200 can connect with one or more interface applications 230 or data sources 260. This connection may be over a network 240 (or multiple networks). The platform 200 may receive and transmit data from one or more of these via I/O unit 202. When data is received, I/O unit 202 transmits the data to processor 204.

The I/O unit 202 can enable the platform 200 to interconnect with one or more input devices, such as a keyboard, mouse, camera, touch screen and a microphone, and/or with one or more output devices such as a display screen and a speaker.

The processor 204 can be, for example, any type of general-purpose microprocessor or microcontroller, a digital signal processing (DSP) processor, an integrated circuit, a field programmable gate array (FPGA), a reconfigurable processor, or any combination thereof.

The data storage 210 can include memory 208, database(s) 212 and persistent storage 214. Memory 208 may include a suitable combination of any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. Data storage devices 210 can include memory 208, databases 212 (e.g., graph database), and persistent storage 214.

The communication interface 206 can enable the platform 200 to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g., Wi-Fi, WiMAX), SS7 signaling network, fixed line, local area network, wide area network, and others, including any combination of these.

The platform 200 can be operable to register and authenticate users (using a login, unique identifier, and password for example) prior to providing access to applications, a local network, network resources, other networks and network security devices. The platform 200 can connect to different machines or entities.

The data storage 210 may be configured to store information associated with or created by the platform 200. Storage 210 and/or persistent storage 214 may be provided using various types of storage technologies, such as solid state drives, hard disk drives, flash memory, and may be stored in various formats, such as relational databases, non-relational databases, flat files, spreadsheets, extended markup files, etc.

The memory 208 may include a weight initialization unit 222, a training input unit 224, a loss optimization unit 226, and a MMoEEx model 225.

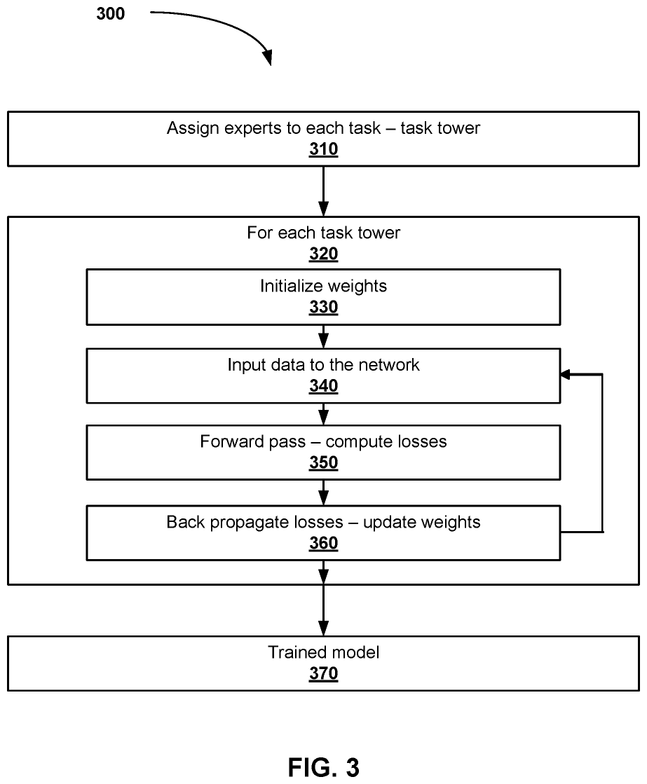

FIG. 3 illustrates, in a flowchart, an example of a method of heterogeneous multi-task learning 300, in accordance with some embodiments. The method 300 may be performed by a system having a plurality of expert machine learning models assigned to a plurality of tasks. The method 300 includes assigning expert models to each task 310 such that, in exclusivity mode, each task is assigned one exclusive expert model with the remaining shared experts fully accessible by the plurality of tasks. In some embodiments, at least one task is assigned one exclusive expert model and at least one shared expert model that is accessible by the plurality of tasks. Next, for each task 320, weights are initialized 330 in the experts and gates. Next, training inputs, which can be single entries or a batch, are provided or input 340 to the multi-task learning network. A forward pass over the network is computed 350, resulting in the losses. The losses are back-propagated and weights for the experts and gates are updated 360. Steps 340 to 360 are repeated for different inputs until a stopping criterion, such as a maximum number of iterations, is satisfied. The final set of weights for MMoEEx are saved for model evaluation and deployment 370. Other steps may be added to the method 300, such as applying the trained MMoEEx model to a live multi-task scenario.

### Experiments

Experiments were developed to answer two questions to validate the MMoEEx method:

(1) MMoEEx has better results than existing MTL baselines, such as MMoE, hard-parameter sharing (shared bottom), multi-channel wise LSTMs (time-series datasets);

(2) MMoEEx has better results than single task learning (STL) methods.

Furthermore, secondary results were explored, such as the influence of the expert complexity and the number of experts on the results, and the comparison of expert's diversity in the MMoEEx method and the main baseline.

### Datasets

The performance of MMoEEx was evaluated on three datasets. UCI-Census-income dataset, Medical Information Mart for Intensive Care (MIMIC-III) database, and PubChem BioAssay (PCBA) dataset. A common characteristic among all datasets is the presence of very unbalanced tasks (few positive examples).

UCI—Census-income dataset. Extracted from the US 1994 census database, there are 299285 answers and 40 features, extracted from the respondent's socioeconomic form. Three binary classification tasks are explored using this dataset:

(1) Respondent income exceeds $50K;

(2) Respondent's marital status is “ever married”;

(3) Respondent's education is at least college;

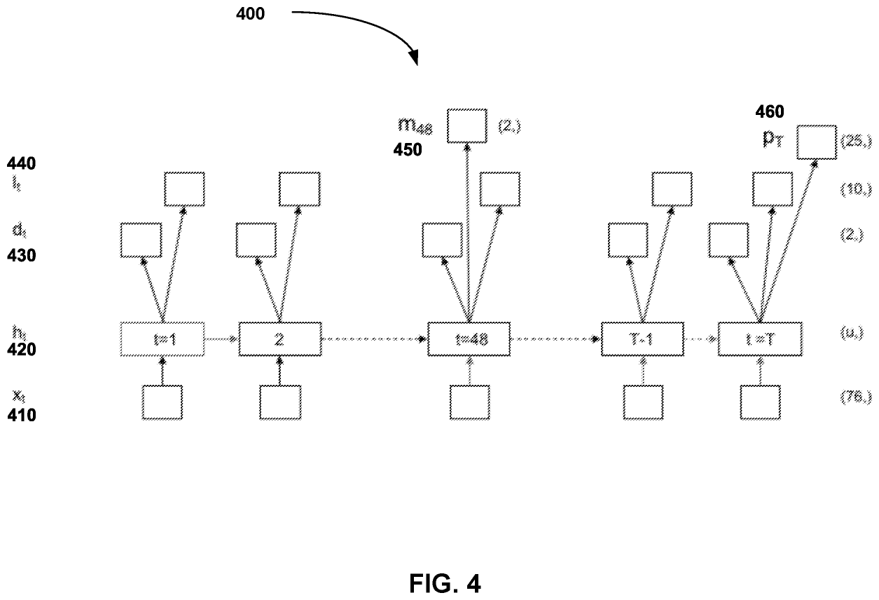

Medical Information Mart for Intensive Care (MIMIC-III) database. This database was proposed to be a benchmark dataset for MTL in time-series data. It contains metrics of patients from over 40,000 intensive care units (ICU) stays. This dataset has 4 tasks: two binary tasks, one temporal multi-label task, and one temporal classification. FIG. 4 shows the input diagram of MIMIC-III to MMoEEx 400, where each task input is defined.

FIG. 4 illustrates an example of the input setting for MMoEEx 400, in accordance with some embodiments.

The input data xₜ 410 has 76 features, and the size of the hidden layer hₜ 420 depends on the model adopted. There are four tasks: the decompensation dₜ 430 and LOS lₜ 440 calculated at each time step, mortality m₄₈ 450, and the phenotype p_{T} 460, both calculated only once per patient.

Tasks description:

(1) Phenotype prediction 460: measured on the end of stay, classify if the patient has 25 acute care conditions (p_{T} in FIG. 4). In practice, there are 25 parallel binary classification tasks;

(2) Length-of-stay (LOS) prediction 440: the goal is to predict the remaining time spend in ICU at each hour of stay (lₜ in FIG. 4). The remaining time was converted from a regression task to a multi-label task. There are 10 classes, one class for each one of the first 8 days, between 8-15 days, and +15 days;

(3) Decompensation prediction 430: aim to predict if the patient state will rapidly deteriorate in the next 24 hours. Due to lack of a gold standard, the task is redefined as mortality prediction in the next 24 hours at each hour of an ICU stay. In practice, this is a temporal binary classification (dₜ in FIG. 4);

(4) In-hospital mortality prediction 450: binary classification in the end of the first 48 hours of a patient in an ICU stay (m₄₈ in FIG. 4).

PubChem BioAssay (PCBA) Database. A subset of the PCBA was used, composed of 128 binary tasks/biological targets and 439863 samples. Each sample represents a molecule, pre-processed using Circular Fingerprint molecule feature extractor, that creates 1024 features. These features are used to determine whether the chemical affects a biological target, here defined as our tasks.

### Design of Experiments

The split between train, validation, and test set was the same used by the baselines to offer a fair comparison. For the UCI-Census, the split was 66%/17%/17% for training/validation/testing sets, for the MIMIC-III and PCBA 70%/15%/15%. The data pre-processing, loss criterion, optimizers, parameters, and metrics description of the experiments is shown below. The metric adopted to compare results is AUC (Area Under The Curve) ROC (Receiver Operating Characteristic) for the binary tasks and Kappa Score for the multiclass tasks.

### UCI—Census-Income Study

Experimental results on the census-income data will now be discussed. Two different sets of experiments are presented: the first version predicts income and marital status, and the second predicts income, marital status, and education level.

Table 1 shows the comparison between MMoEEx against single task trained MMoEs, shared bottom networks and the multi-task MMoE. As is shown, MMoEEx obtains the best performance for the income task, but does not achieve the best overall results among the analysed baselines. Another characteristic of this experiment is the limited number of tasks, which can be considered a weak MTL benchmark configuration. In order to further explore the census dataset, the number of tasks is increased to be more suitable for a MTL formulation.

TABLE 1
Results on Census income/marital dataset.

| | AUC | | |
|---|---|---|---|
| Method | Income | Marital Stat | Δ |
| Single-Task | 88.95 | 97.48 | — |
| Shared-Bottom | 89.59 | 98.08 | +0.67% |
| MMoE | 86.12 | 96.82 | −1.93% |
| MMoEEx | 89.74 | 97.28 | +0.34% |

Δ is the average relative improvement

Experimental results of experiments predicting income, marital status and education level on the census-income data will now be presented and discussed. The census income, marital status and education dataset experiments are presented at Table 2. As is shown, MMoEEx outperforms all the baselines with the exception of the Education task where the single task method presents a marginal improvement over MMoEEx. The Census tasks already present slightly conflicting optimization goals, and in the is situation, the MMoEEx is better suited to balance multiple competing tasks. With three tasks, conflicting optimization goals are encountered and, in this situation, MMoEEx is better able to balance the multiple competing tasks.

TABLE 2
Results on Census income/marital/Education dataset.

| | AUC | | | |
|---|---|---|---|---|
| Method | Income | Marital Stat | Education | Δ |
| Single-Task | 88.95 | 97.48 | 87.23 | — |
| Shared-Bottom | 91.09 | 97.98 | 86.99 | +0.85% |
| MMoE | 90.86 | 96.70 | 86.33 | −0.28% |
| MMoEEx | 92.51 | 98.47 | 87.19 | +1.65% |

Δ is the average relative improvement

The MMoEEx approach can better learn multiple tasks when compared to standard shared bottom approaches and the MMoE baseline, due to the exclusivity and the multi-step optimization contributions of our work.

### MIMIC-III Study

MIMIC-III dataset is the main benchmark for heterogeneous MTL with time series. The dataset consists of a mixture of multi-label and single-label temporal tasks and two non-temporal binary classification tasks. The experiments investigated the best recurrent layers to be selected as experts to the MMoEEx model. An ablation study is presented on the impact of higher experts cardinality and the full scale baseline evaluation.

Recurrent Modules Ablation Study. One of the main design choices for time series prediction is the type of recurrent unit to be deployed. The goal of this ablation study is to provide a thorough analysis on the impact of different recurrent layers to the MMoEEx approach. The layers taken into consideration range from the standard RNN's, LSTM's and GRU's to modern recurrent layers like the Simple Recurrent Units (SRU) and Independent Recurrent Networks (IndRNN).

TABLE 3
Results on MIMIC-III recurrent modules ablation study. All
the MMoEEx configurations count with 12 experts based on
memory limitations of approaches like IndRNN and LSTM.

| Method | Pheno | LOS | Decomp | Ihm |
|---|---|---|---|---|
| MMoEEs-SRU | 71.00 | 57.88 | 96.67 | 89.95 |
| MMoEEx-IndRNN | 67.49 | 57.11 | 95.89 | 91.68 |
| MMoEEx-IndRNNV2 | 68.15 | 54.48 | 96.50 | 90.58 |
| MMoEEx-LSTM | 73.48 | 45.99 | 96.54 | 90.88 |
| MMoEEx-RNN | 73.40 | 55.56 | 96.85 | 91.08 |
| MMoEEx-GRU | 74.08 | 54.48 | 97.20 | 91.49 |

MIMIC-III recurrent modules ablation study is presented in Table 3. SRU and IndRNN outperform the other methods from length-of-stay (LOS) task. MMoEEx with IndRNN also is the top performer for the in-hospital mortality (Ihm) task. Besides the good performance of SRU and IndRNN for these tasks, they present an imbalanced performance over all considered tasks and also impose a memory and runtime burden, making the scalability of MMoEEx to higher number of experts infeasible. Taking the overall task performance into consideration, RNN and GRU outperform the compared recurrent approaches. RNN, in addition to being a top performer expert, also presented the lowest memory footprint and consequently is capable of providing MMoEEx with more experts if needed.

From this part on, MMoEEx's with RNN's or GRU's as their recurrent layers are used.

Impact of experts cardinality. During the training of MMoEEx for the MIMIC-III experiments, a larger number of experts, when connected with the exclusivity mechanism, gave better overall results. In order to further explore this parameter, a series of experiments were conducted where MMoEEx with RNN's was trained with a number of experts ranging from 12 to 64 experts. RNN's were selected as the recurrent layer in this experiment based on its low memory requirement.

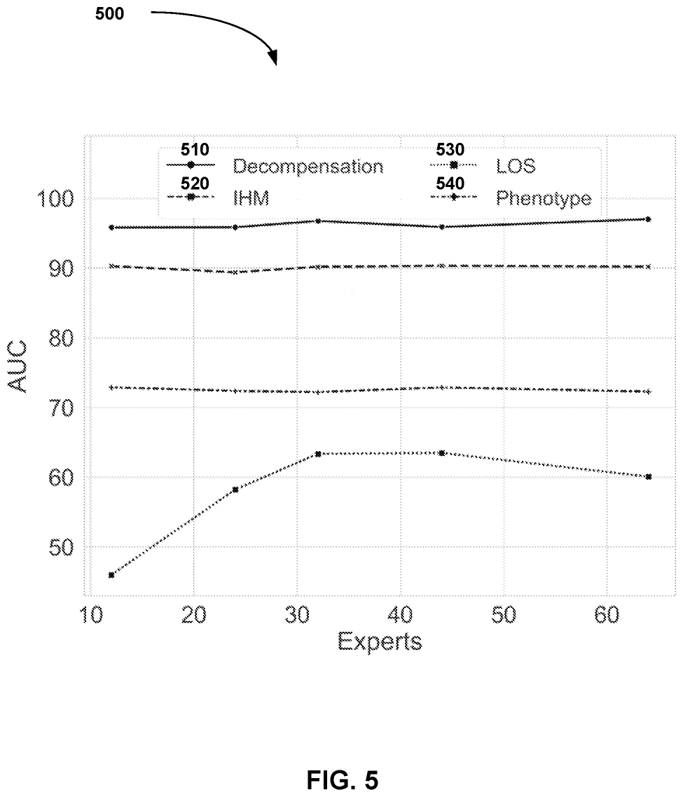

FIG. 5 illustrates, in a graph, the impacts of cardinality of experts for the MMoEEx model on MIMIC-III 500, in accordance with some embodiments. FIG. 5 depicts results for the four tasks on the MIMIC-III dataset. LOS tasks is the one that take most advantage of a larger number of experts with an improvement superior to 17 percentage points or a 38 percent relative improvement. The remaining tasks are stable for a higher cardinality of experts. A higher number of experts allow MMoEEx to have a better representation to challenging tasks when the shared representation is not been updated with the same magnitudes due to the other tasks have reached stability. The number of 32 experts gave MMoEEx the best overall and LOS performance. The final results on MIMIC-III are all using 32 experts.

TABLE 4
Final results MIMIC-III. MMoEEx outperforms all the
compared baselines with the exception to Phenotype
540. MMoEEx can provide a relative improvement superior
to 40 percentage points when compared to the Multitask
channel wise LSTM for the LOS 530 task.

| | Pheno | LOS | Decomp | Ihm | |
|---|---|---|---|---|---|
| Method | 540 | 530 | 510 | 520 | Δ |
| MCW-LSTM | 77.4 | 45.0 | 90.5 | 87.0 | +0.28% |
| Single Task | 77.0 | 45.0 | 91.0 | 86.0 | — |
| Shared | 73.36 | 30.60 | 94.12 | 82.71 | −9.28% |
| Bottom | | | | | |
| MMoE | 75.09 | 54.48 | 96.20 | 90.44 | +7.36% |
| MMoEEx-RNN | 72.44 | 63.45 | 96.82 | 90.73 | +11.74% |
| MMoEEx-GRU | 74.57 | 60.63 | 97.03 | 91.03 | +11.00% |

MiMIC-III Results. The full set of results for MIMIC-III dataset is presented in Table 4. MMoEEx was compared with the multitask channel wise LSTM (MCW-LSTM), single task trained network, shared bottom, MMoE and two variations of MMoEEx with RNN's and GRU's.

MMoEEx outperforms all the compared approaches except on the Phenotype (Pheno) 540 task. For both time series tasks (LOS 530 and Decomposition (Decomp) 510) the approach outperforms all baselines. It is worth noting that for the LOS 530 task, which is the hardest task on MIMIC-III, a relative improvement superior to 40 percentage points is shown when compared to multitask channel wise LSTM and over 16 percentage points to MMoE for our MMoEEx with Recurrent Neural Networks (RNN's). MMoEEx with GRU's presents a better individual task performance than its RNN counterpart but with lower LOS 530 task performance.

TABLE 5
PCBA's final results. MMoEEx has competitive
results when compared with the baselines.

| | Average | Std | | | |
|---|---|---|---|---|---|
| Method | AUC | Dev | CI (95%) | NT | Δ |
| STL | 79.9 | 10.62 | [78.04, 81.72] | — | — |
| MTL | 85.7 | 8.75 | [84.20, 87.24] | 13 | +8.51% |
| Fine Tuning | 80.6 | 10.46 | [78.79, 82.42] | 50 | +0.87% |
| GradNorm | 84.0 | 7.98 | [82.58, 85.35] | 44 | +5.13% |
| RMTL | 85.2 | 8.77 | [83.71, 86.75] | 11 | +6.63% |
| LBTW(α = 0.1) | 85.9 | 8.49 | [84.45, 87.39] | 13 | +7.51% |
| LBTW(α = 0.5) | 86.3 | 8.09 | [84.86, 87.67] | 11 | +8.01% |
| Shared Bottom | 86.8 | 8.53 | [84.62, 87.58] | 10 | +8.63% |
| MMoE | 85.8 | 8.83 | [84.10, 87.16] | 15 | +7.38% |
| MMoEEx | 85.9 | 8.61 | [84.18, 87.16] | 13 | +7.50% |

NT is Negative Transfer, Δ is Average Relative Improvement.

### PubChem BioAssay Dataset Study

The PCBA dataset has 128 tasks and is the main benchmark for scalability and negative transfer. All the 128 tasks are binary classification tasks, and they are very similar to each other. The experiments first compare MMoEEx with existing baselines on the tasks' average AUC and number of tasks with negative transfer. Then, a second ablation study compared the MMoEEx approach with the MMoE on the number of experts and overfitting evaluation.

Comparison with existing baselines. A shared bottom and a MMoE techniques were included to the baselines.

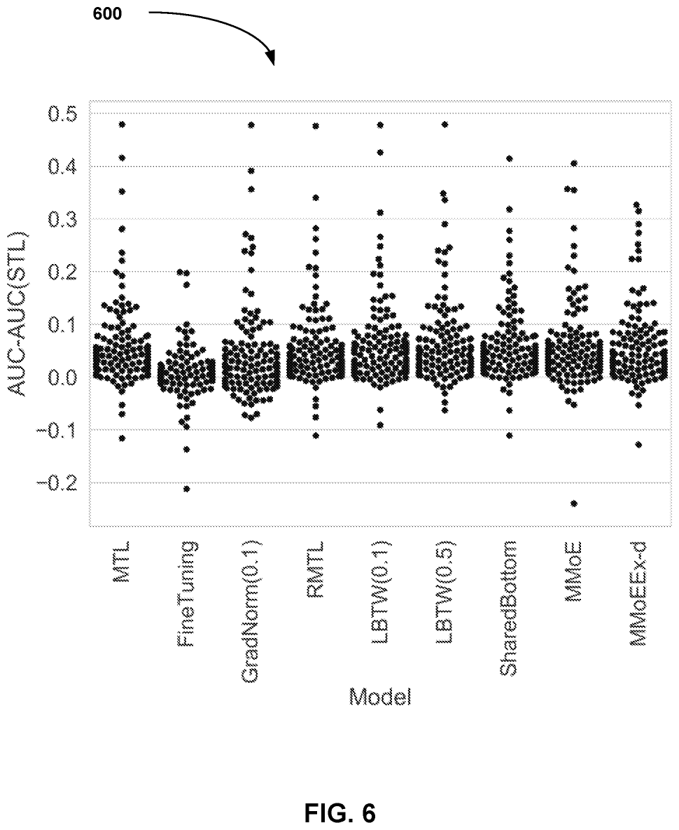

The architecture adopted for baselines and experts is very similar (as described further below). For this application, MAML-MTL optimization was not used due to scalability issues. Therefore, the difference between the MMoE and MMoEEx in this application is the diversity of experts: all MMoE's experts are shared among all tasks, versus only a portion of MMoEEx are shared. Table 5 shows the final results. Four metrics were adopted to compare the results with the baselines: the average ROC AUC of all tasks, Standard Deviation of the ROC AUC, Δ, and the number of negative transfer (NT). The NT is calculated using Single Task Learning Models, and counts how many tasks have a worse result on the multi-task learning approach. FIG. 6 shows the improvement of each model in comparison with the STL model, where tasks below 0 indicates NT.

FIG. 6 illustrates, in a plot diagram, change on the AUC for each task k∈{1, . . . , 128} relative to the single-task learning (STL) AUC 600, in accordance with some embodiments. Values below 0 indicate negative transfer. Considering all the baselines, the shared bottom fitted in our study has the best overall result (largest average AUC, smaller NT). Using the tasks AUC, 95% confidence intervals were constructed, shown in Table 5, from where it is seen that there is no significant difference between RMTL, MTL, LBTW, Shared Bottom, MMoE, and MMoEEx. Therefore, the proposed method MMoEEx has a competitive result when compared with other baselines. LBTW and GradNorm are both focused on task balancing. However, the PCBA dataset has very similar tasks, which almost makes unnecessary the task balancing component. The shared bottom model, for example, does not have any task balancing approach and has the best performance overall.

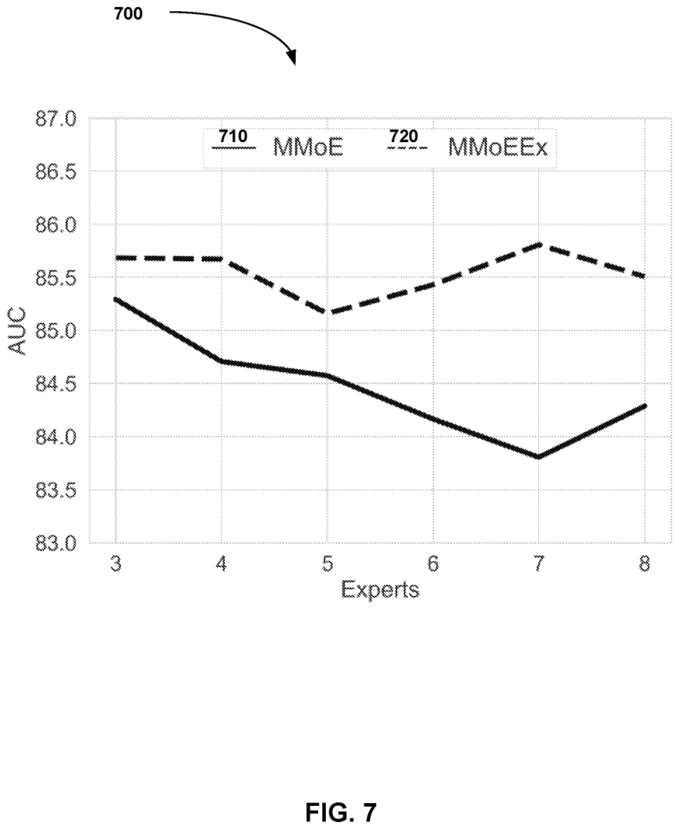

FIG. 7 illustrates a comparison of the ROC AUC 700 versus number expert in the MMoE 710 and MMoEEx 720, in accordance with some embodiments.

Impact of number of experts. A direct comparison is seen between MMoEEx and the main baseline MMoE. In this dataset, fixing the same number of experts, MMoEEx has a better average ROC AUC on the testing set than the MMoE, as FIG. 7 shows. In some embodiments, the number of shared experts in the MMoEEx may be fixed (e.g., to 2). With three experts, α=0.42, and to each new expert added, the value of α may be incremented by 0.09. Therefore, with eight experts, there may be two shared experts and α=0.87. FIG. 7 shows that the inclusion of more diversity on the experts through expert exclusivity helped the model to generalize better on the testing set and decreased overfitting.

### Diversity Score Study

In some embodiments, a diversity measurement shows that MMoEEx induced more diversity among the experts than the baseline MMoE.

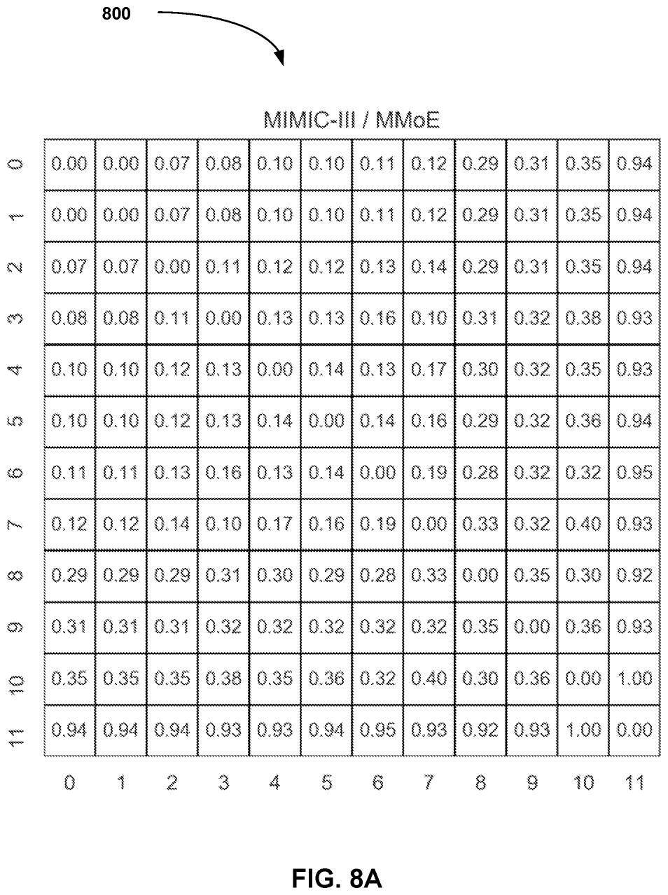

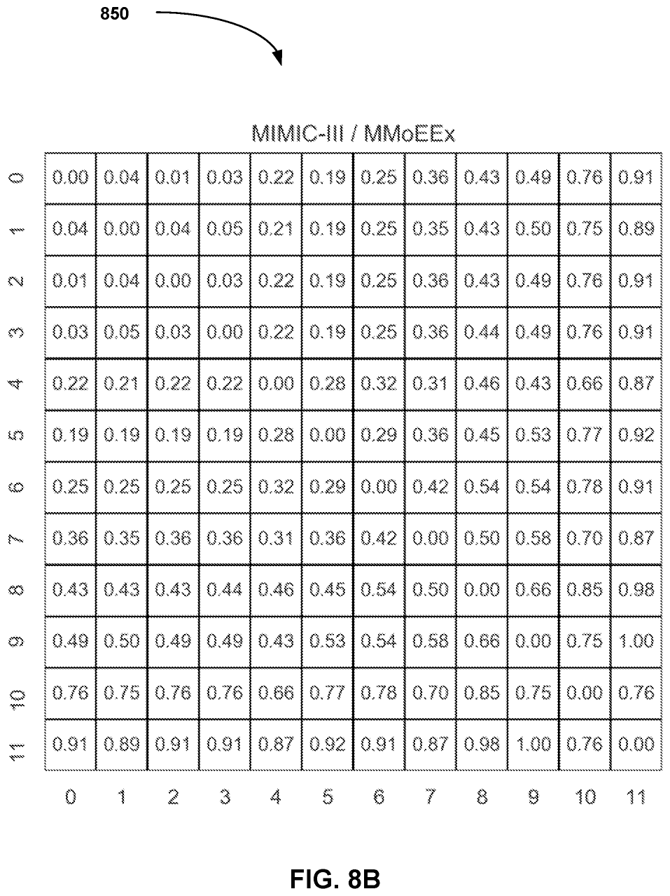

FIGS. 8A and 8B illustrate, in plot diagrams, MMoE (d̅=0.311) and MMoEEx (d̅=0.445) heatmaps 800, 850 in the MIMIC-III dataset, in accordance with some embodiments. The MMoE has 12 shared experts versus 6 shared and 6 exclusive experts in the MMoEEx model. More dissimilarities between two experts indicate more diversity. The plot is generated with 12 instead of 32 experts to better visualize the distances; the results also hold in the setting with 32 experts.

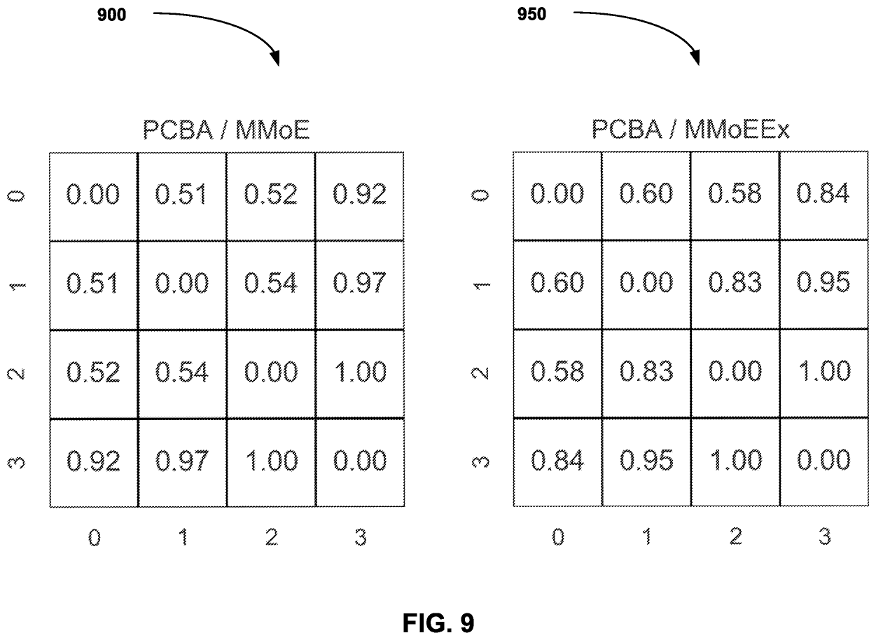

FIG. 9 illustrates, in a plot diagram, MMoE (d̅=0.557) and MMoEEx (d̅=0.600) heatmaps 900 for the PCBA dataset, in accordance with some embodiments. The MMoEEx model has 2 shared experts and 2 experts with exclusion.

The diversity score of the MMoE and MMoEEx in the benchmark datasets will now be analyzed. The MMoE and MMoEEx models compared using the same dataset have the same neural network structure, but the MMoEEx uses the MAML-MTL optimization and has the diversity enforced. The MMoEEx models in FIGS. 8A and 8B were generated with α=0.5 and exclusivity. In other words, half of the experts in the MMoEEx models were randomly assigned to be exclusive to one of the tasks, while the MMoE results have α=0 (all experts shared among all tasks). FIGS. 8A and 8B show heatmaps 800, 850 of the distances DMMoE and DMMoEEx calculated on the MIMIC-III testing set with 12 experts. The MMoE's heatmap 800 has, overall, a smaller diversity score than the MMoEEx heatmap 850. FIG. 9 shows the MMoE and MMoEx heatmaps 900, 950 for the PCBA dataset, with 128 tasks and 4 experts. MMoEEx also has a larger diversity score d̅.

In summary, MMoEEx works well on the heterogeneous dataset, MIMIC-III, increasing the diversity score by 43.0%. The PCBA is a homogeneous dataset, but the diversity component still positively impacts and increases the diversity score by 7.7%. Finally, as the most homogeneous and simplest dataset adopted in the study, the Census dataset is the only one that does not take full advantage of the experts' diversity. MMOE's diversity score was 0.410 versus 0.433 for the MMoEEx's model, which is a 5.6% improvement.

These results show that MMoEEx indeed increased the experts' diversity while keeping the same or better tasks' AUC (see Tables 2, 5 and 4).

### Experiments Reproducibility

PyTorch was used in the implementation, and the code is available at github.com/url_hidden_for_double_blind_submission. Adam optimizer with learning rate 0.001, weight decay 0.001, and learning rate decreased by a factor of α=0.9 every ten epochs was used. The metric adopted to compare the models was ROC AUC, with the exception of the task LOS on MIMIC-III dataset, which was Cohen's kappa Score, a statistic that measures the agreement between the observed values and the predicted. The models were trained using the training set, and the task's AUC sum was used in the validation set to define the best model, where the largest sum indicates the best epoch, and consequently, the best model. Table 6 shows a summary of the models adopted for future reference.

TABLE 6
Models' architecture, training information, and dataset pre-processing's
references for experiment reproducibility purposes.

| | Pre- | | | | |
|---|---|---|---|---|---|
| Dataset | processing | Epochs | Experts | Loss | Layers |
| UCI- | Ma et al. | 200 | 12 | BCEWithLogitsLoss | Experts: Linear (4) + ReLU, |
| Census | | | | | Towers: Linear (4) + Linear (1) |
| MIMIC- | Harutyunyan | 50 | 12 and | BCEWithLogitsLoss, | Experts: RNN(128) or GRU(128); |
| III | et al., | | 32 | CrossEntropyLoss | Towers: Linear (16) + Linear |
| | Johnson et al. | | | (multilabel task), | (output), where the output |
| | | | | pos_weight: | depends on the task. Three towers |
| | | | | Pheno = 5, | had time-series data, and one had |
| | | | | LOS = 1, | only the first 24 observations of |
| | | | | Decomp = 25, | the time-series. |
| | | | | Ihm = 5 | |
| PCBA | Liu et al. | 100 | 2 or 4 | BCEWithLogitsLoss, | Linear (2000) + Dropout (0.25) + |
| | | | | pos_weight = 100 | ReLU + Linear (2000) + Sigmoid + |
| | | | | | Linear (2000). Thetower had one |
| | | | | | Linear(1) layer per task. |

A novel multi-task learning approach called multi-gate mixture-of-experts with exclusivity (MMoEEx) was presented, which extends MMoE methods by introducing an exclusivity and exclusion mechanism that induces more diversity among experts, allowing the network to learn representations that are more effective for heterogeneous MTL. A two step optimization approach called MAML-MTL was also presented, which balances tasks at the gradient level and enhances MMoEEx's capability to optimize imbalanced tasks. MMoEEx has better results than baselines in MTL settings with heterogeneous tasks which are more diverse, even in a mix of time series and non-time series tasks (e.g., those frequently found in biological applications). Experiments on biological and clinical benchmark datasets demonstrate the success of MMoEEx in homogeneous and heterogeneous settings, where MMoEEx outperformed several state-of-the-art baselines.

In some embodiments, one task may have larger losses that other tasks. Such larger losses may be bias. In an MMoE system, this can create imbalance because all experts are optimized for highest loss of a task, causing some tasks to not be as optimized. In MMoEEx, periodic/intermediate updates are performed for separate algorithms. Thus, when adding new tasks to learn (and new algorithms), other tasks are not degraded.

It should be noted that the MMoEEx model may be used as an individual expert in a more complex MMoEEx model.

### Simplified Examples

Some simplified examples will now be described. It should be understood that the tasks described in these examples may be solved using other means. However, the examples illustrate some features of the MMoEEx system and methods described herein.

### Photograph Detection

Consider a photograph that includes a building, trees and the sky. A MMoEEx model 100d may be used to locate items in the photograph. Separate tasks may be set to detect one of the buildings, trees or sky. Some expert models may be trained to exclusively learn how to detect one of buildings, trees or sky. Other expert models may be trained to learn how to detect any of buildings, trees or sky (i.e., they are separately trained on each of two or more of the tasks). Gates are set such that weight parameters for each of the expert models are set (for example, each expert model providing a prediction for a task may be initially set to equal weight). A photograph is provided as input and processed. A loss function may determine how accurate the overall MMoEEx model was for each task. The loss values may then be used to adjust the weight parameters in the gates (and in some embodiments one or more expert models), and the same or another photograph may be provided as training input and processed. These training steps are repeated until an optimal set of weight parameters are determined to minimize the loss values for an aggregate of the tasks. The trained model may now be used to detect buildings, trees or sky in future photograph inputs.

### Invoice Forecasting

Consider a billing forecasting application for predicting a date and amount for a client's next invoice. A separate task may be set to predict the next date and the next amount to be invoiced. One expert model may be set to be exclusive to predicting the date and another expert model may be set to be exclusive to predicting the amount. Other expert models may be used for both tasks. Gates are set such that weight parameters for each of the expert models are set (for example, each expert model providing a prediction for a task may be initially set to equal weight). A sequence of the past t−1 historical client invoices are provided as input, and the MMoEEx model determines a “predicted” date and amount for the t^{th} invoice. The loss values may then be used to adjust the weight parameters in the gates (and in some embodiments one or more expert models), and the same or another set of customer invoices may be provided as training input and processed. These training steps are repeated until an optimal set of weight parameters are determined to minimize the loss values for an aggregate of the tasks. The trained model may now be used to predict future customer invoice dates and amounts.

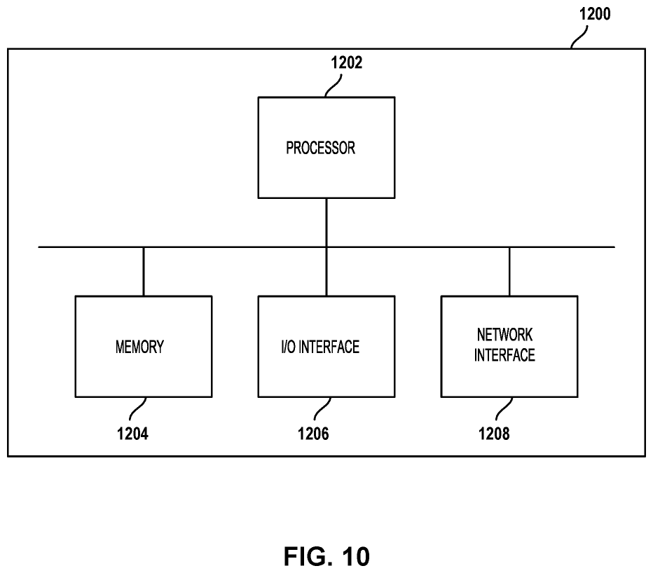

FIG. 10 is a schematic diagram of a computing device 1200 such as a server. As depicted, the computing device includes at least one processor 1202, memory 1204, at least one I/O interface 1206, and at least one network interface 1208.

Processor 1202 may be an Intel or AMD x86 or x64, PowerPC, ARM processor, or the like. Memory 1204 may include a suitable combination of computer memory that is located either internally or externally such as, for example, random-access memory (RAM), read-only memor (ROM), compact disc read-only memory (CDROM).

Each I/O interface 1206 enables computing device 1200 to interconnect with one or more input devices, such as a keyboard, mouse, camera, touch screen and a microphone, or with one or more output devices such as a display screen and a speaker.

Each network interface 1208 enables computing device 1200 to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others.

The discussion provides example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements.

Although the embodiments have been described in detail, it should be understood that various changes, substitutions and alterations can be made herein.

Moreover, the scope of the present application is not intended to be limited to the particular embodiments of the process, machine, manufacture, composition of matter, means, methods and steps described in the specification.

As can be understood, the examples described above and illustrated are intended to be exemplary only.

What is claimed is:

1. A system for training a heterogeneous multi-task learning network, the system comprising:
at least one processor; and
a memory comprising instructions which, when executed by the processor, configure the processor to:
assign expert models to each task in the multi-task learning network, at least one task assigned one exclusive expert model and at least one shared expert model accessible by the plurality of tasks;
for each task:
initialize weight parameters in the expert models and in gate functions;
provide training inputs to the multi-task learning network;
determine a loss following a forward pass over the multi-task learning network; and
back propagate losses and update weight parameters for the expert models and the gate functions; and
store a final set of weight parameters for use in a trained model for multiple tasks.

2. The system as claimed in claim 1, wherein the at least one processor is configured to provide input to the trained model to perform the multiple tasks.

3. The system as claimed in claim 1, wherein each expert model comprises one or more neural networks layers.

4. The system as claimed in claim 3, wherein one of:
temporal data is provided as input and the expert models comprise recurrent layers; or
non-temporal data is provided as input and the expert models comprise dense layers.

5. The system as claimed in claim 1, wherein the gate functions comprise an exclusivity mechanism for setting expert models to be exclusively connected to one task.

6. The system as claimed in claim 1, wherein the gate functions comprise an exclusion mechanism for setting expert models to be connected such that they are excluded from some tasks.

7. The system as claimed in claim 1, wherein the steps for each task are repeated for different inputs until a stopping criterion is satisfied.

8. The system as claimed in claim 1, wherein the at least one processor is configured to perform a two-step optimization to balance the tasks on a gradient level.

9. The system as claimed in claim 8, wherein the two-step optimization comprises a modified model-agnostic meta-learning where task specific layers are not frozen during an intermediate update.

10. The system as claimed in claim 1, wherein at least one individual expert model comprises another multi-task learning network.

11. A computer-implemented method of training a heterogeneous multi-task learning network, the method comprising:
assigning expert models to each task in the multi-task learning network, at least one task assigned one exclusive expert model and at least one shared expert model accessible by the plurality of tasks;
for each task:
initializing weight parameters in the expert models and in gate functions;
providing training inputs to the multi-task learning network;
determining a loss following a forward pass over the multi-task learning network; and
back propagating losses and updating weight parameters for the expert models and the gate functions; and
storing a final set of weight parameters for use in a trained model for multiple tasks.

12. The method as claimed in claim 11, comprising providing input to the trained model to perform the multiple tasks.

13. The method as claimed in claim 11, wherein each expert model comprises one or more neural networks layers.

14. The method as claimed in claim 13, wherein one of:
temporal data is provided as input and the expert models comprise recurrent layers; or
non-temporal data is provided as input and the expert models comprise dense layers.

15. The method as claimed in claim 11, wherein the gate functions comprise an exclusivity mechanism for setting expert models to be exclusively connected to one task.

16. The method as claimed in claim 11, wherein the gate functions comprise an exclusion mechanism for setting expert models to be connected such that they are excluded from some tasks.

17. The method as claimed in claim 11, wherein the steps for each task are repeated for different inputs until a stopping criterion is satisfied.

18. The method as claimed in claim 11, wherein the at least one processor is configured to perform a two-step optimization to balance the tasks on a gradient level.

19. The method as claimed in claim 18, wherein the two-step optimization comprises a modified model-agnostic meta-learning where task specific layers are not frozen during an intermediate update.

20. The method as claimed in claim 11, wherein at least one individual expert model comprises another multi-task learning network.
